(19) United States
(12) Patent Application Publication
(10) Pub. No.: US 2016/0321663 A1
(43) Pub. Date: Nov. 3, 2016

(54) ELECTRONIC PAYMENT AND BUDGETING SYSTEM UTILIZING CONFIGURABLE PAYMENT CARDS

(71) Applicant: PAYPAL INC., San Jose, CA (US)

(72) Inventor: Eduardo Alfonso Batlle, Austin, TX (US)

(21) Appl. No.: 14/699,980

(22) Filed: Apr. 29, 2015

(51) Int. Cl. G06Q 20/40

(52) U.S. Cl. CPC G06Q 20/409; G06Q 20/405

(57) ABSTRACT

Systems and methods are disclosed for allocating funds from a primary account to one or more configurable payment cards for use in a payment transaction. An electronic transaction system includes an account database storing account and configurable card data for a user. A budget module enables the user to allocate funds to various virtual accounts and assign configurable cards to each virtual account, and configure resource limitations and use restrictions on each virtual account and configurable card. A user device provides an interface for managing the account, budget and configurable card information and receives a real-time account, budget and configurable card information. The configurable cards may be used to make payments through a merchant's point-of-sale system which interfaces with the electronic transaction system to authenticate the card transaction.

### TECHNICAL FIELD

The present application relates generally to configurable transaction cards and more specifically to systems and methods for managing funds and processing payment transactions using configurable payment cards.

### BACKGROUND

The widespread growth and convenience of electronic payment systems has led to a reduced use of cash by consumers. Electronic payment systems include systems that facilitate credit card, debit card and electronic wallet transactions. A user may open an account with a financial institution or electronic commerce entity that provides electronic payment services. A credit card or debit card issued by the entity allows the user to make payments and transfer funds from the user account. Mobile devices, such as smartphones, are also used to make electronic payments through a digital wallet or electronic payment service. A prepaid card or gift card may be purchased for use by individuals who desire to make an electronic payment, but do not have access to an account with an e-commerce services provider.

Consumer budgeting, which often requires financial planning and disciplined spending, is not a primary feature of most electronic payment systems. A credit card, for example, provides a consumer with an always available, easy to use spending source which may include high credit limits, interest charges and other fees associated with the use of the card. A prepaid card or gift card can be used to set spending limits, but these cards often go unspent and the remaining funds may be lost if the card is not used or is misplaced. There is a need for an electronic payment system that allows the account holder with greater control over budgeting and account use.

### BRIEF DESCRIPTION OF THE DRAWINGS

FIG. 1 is a flow diagram illustrating an embodiment of an exemplary electronic payment process using a configurable payment card;

FIG. 2 is an embodiment of an exemplary network system suitable for processing a payment transaction using a configurable payment card;

FIG. 3 is an embodiment of an exemplary network system suitable for processing a payment transaction using a configurable payment card;

FIG. 4 is a flow diagram illustrating an exemplary electronic payment transaction using a merchant point-of-sale system;

FIG. 5 is a flow diagram illustrating an embodiment of an exemplary electronic payment transaction performed by a transaction processing server;

FIG. 6 is a diagram illustrating an embodiment of an exemplary electronic payment process using location-based restrictions;

FIG. 7 illustrates an embodiment of an exemplary database record structure;

FIG. 8 is a flow diagram illustrating an embodiment of an exemplary budgeting process; and

FIG. 9 is an embodiment of an exemplary processing system suitable for implementing one or more components in FIGS. 2, 3, and 6.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for processing electronic payment transactions through a user controlled, configurable payment card system. Systems suitable for practicing methods of the present disclosure are also provided.

In various embodiments, a user device (e.g., a mobile phone) is configured to access a transaction processing server of a financial institution or e-commerce service provider through a network (e.g., the Internet). The user device provides a user interface giving the account holder access to a primary user account and allowing the account holder to request one or more configurable payment cards, allocate funds to each configurable payment card and set corresponding restrictions on the use of each configurable payment card. The account holder may also allocate or transfer funds from the primary user account to the configurable card for use as a credit card, debit card or other electronic payment card. In various embodiments, the allocation of funds to the card may be instructed manually by the account holder or automatically through a set of allocation rules established by the account holder. Restrictions on the use of the configurable card may include, for example, spending limits, time, date and location restrictions and context-based restriction on the use of allocated funds.

The configurable payment card system described herein may be used in any environment where the account holder desires to allocate and/or restrict the use of the account funds using a payment card or electronic device. In one embodiment, a parent assigns a configurable payment card to a child with limited funds allocated from the parent account for an allowance. The parent may log onto the parent's primary account to set up rules to automatically allocate a fixed amount of available funds to the child's configurable card on a regular basis (e.g., weekly), and to set up context-based restrictions on the child's spending that are limited to certain merchants and certain types of purchases that are appropriate for the child. Through the user device, the parent can receive real time notification of the child's spending on the configurable card, and can further set up the configurable card to require parental approval of purchases made using the configurable payment card. If the card is lost or stolen, the use restrictions can limit the opportunities for fraudulent use of the card and the parent can deactivate the card and issue a new configurable card to the child.

In another embodiment, a configurable card may be set up for an online purchase where the user is concerned about fraudulent use of the account number. A new configurable payment card can be activated and funded with spending limits and an expiration date and use restrictions that are consistent with the intended use of the online service.

In another embodiment, a configurable card is set up as a one-time use card for use at a single location or event. For example, the one-time use, configurable payment card may be handed to a merchant in order to set up a payment tab for food and drink purchases at an eating establishment. The merchant uses the card through a point-of-sale system which communicates with the transaction processing server to authorize and open the payment tab. The merchant system may include a display showing card restriction information, such as one or more photos of users in the cardholder's group who are authorized to make purchases on the tab. Real time spending information can be sent to the user's device to track purchases on the tab. The account holder may establish a spending limit for the card and other restrictions such a location-restriction that disables the card when the user device is detected outside the geographic vicinity of the merchant. In this manner, the user account holder may allow a group to charge purchases on his card without the concern of running up a bill that exceeds the expected budget and the tab will automatically close when the account holder leaves the premises. The one-time use card may then be thrown away by the merchant after use.

The configurable payment card system described herein may also be used within a budget management system. The user account may allocate funds to one or more configurable cards which represent budget categories. In one embodiment, the user defines virtual accounts such as savings, meals, clothes, gifts, and entertainment, and each configurable card is associated with one or more virtual accounts. The configurable card is then limited to the allocation and use restrictions of the associated virtual account. Allocations may be manually instructed by the account holder or automatically carried out in accordance with rules set up by the account holder. For example, the account holder may establish rules to automatically allocate the user's paycheck across various virtual accounts and assign unused funds to a savings account. In operation, the account holder may access the user account or configurable card information to see in real time the current balance on the card before making a purchase.

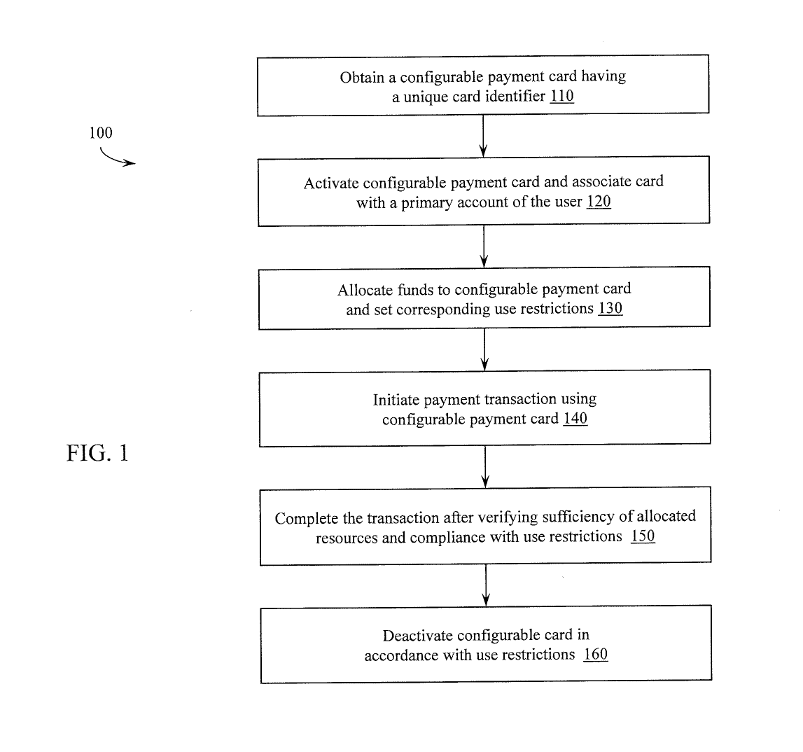

Referring to FIG. 1, a flow diagram 100 illustrating an embodiment of an exemplary electronic payment process using a configurable payment card will now be described. In step 110, an account holder obtains a configurable payment card having a unique card identifier. In one embodiment, the user operates a device, such as a mobile phone, to access a corresponding user account managed by an electronic commerce service provider or financial institution (collectively “payment service provider”), and requests delivery of one or more configurable payment cards associated with the user account. The configurable payment card may be a physical card such as or in the form factor of a credit card, debit card, ATM card, gift card or smart card that is delivered by courier by the service provider, purchased at a retail location or otherwise acquired by the user. Alternatively, the configurable payment card may be an electronic card delivered to the user device across a network, a smart device such as a programmable key FOB or other device configured to facilitate electronic payment on the user's account.

In step 120, the user activates the configurable payment card and associates the card to a primary account of the user. Activation of a configurable card includes instructing the payment service provider to associate the unique card identifier with the user's personal account number. In one embodiment, a user device includes an interface allowing the user to securely log onto the primary account and access account administration features through a server of the payment service provider. Secure communications with the payment service provider may be established, for example, through one or more of encryption, user authentication and device authentication. In various embodiments, the user may be authenticated though a username and password, biometric reading such as a fingerprint scanner or eye/retinal scanner, a user PIN or other security capabilities of the user device. In various embodiments, the user device may be authenticated through a device identifier, a secure token, encryption key exchange or other authentication protocols.

The unique card identifier from a physical card may be read electronically (e.g., a magnetic strip reader, RFID reader) by the user device, acquired visually (e.g., photograph the configurable payment card, scan a bar code or QR code), input manually by the user or otherwise acquired in accordance with the configuration of the configurable payment card. Electronic cards may include additional security such as payment tokens, encryption keys and digital certificates that identify and authenticate the card to the payment service provider.

After activating the configurable payment card, the user configures resource allocation rules and use restrictions for the card in step 130. In various embodiments, resource allocation may include establishing a spending limit on a credit card or allocating available funds from a user account to the configurable payment card in a debit, prepaid or gift card configuration. The resources may be manually allocated through the interface on the user device or automatically allocated through allocation rules set by the user. Use restrictions for the configurable payment card may include time, location, context-based, spending limits and other restrictions on the use of available funds through the card.

The funds allocation rules may also include budget rules established by the user that allocate funds to the configurable payment card consistent with the user's budgetary goals. In one embodiment, the user establishes one or more virtual accounts allowing the user to allocate funds among separate budget categories (e.g., utilities, recurring payments, food, entertainment, gifts, and savings). The configurable payment card is then associated with a virtual account with existing spending limits and use restrictions. In one embodiment, the user may view and modify card restrictions through a card module on the user device which receives use information from a transaction processing server of the payment service provider (e.g., real-time alerts to the user device).

In step 140, the activated configurable payment card is used as payment in a financial transaction. In one embodiment, the financial transaction is an electronic purchase from a merchant and the configurable payment card is operable with the merchant's point-of-sale system. The merchant system acquires the unique card identifier from the card, including identification of the payment service provider that issued the card, and authenticates the user as appropriate (e.g., by checking user ID). The merchant system forwards the transaction information to the payment service provider's transaction processing server which identifies the user account associated with the card, verifies available resources and compliance with use restrictions for the configurable payment card, and authorizes or rejects the transaction as appropriate.

In step 150, the transaction is completed by the merchant after the payment service provider authorizes the payment, such as by transmitting a response message to the merchant with an authorization code. In one embodiment, the configurable payment card is a bank card and the transaction is processed using the merchant's bank card point-of-sale system, which may include the merchant's financial institution, a card network and other parties as required and subsequent clearing and funding of the payment transaction.

In step 160, the card may be deactivated in accordance with use restrictions, which may include configuring the card as a one-time use card, a gift card, a pre-paid card, or the passage of a user specified expiration date. Deactivation may be triggered automatically (e.g., upon depletion of allocated funds, passage of time, or reaching a limit on the card, such as number of uses) or manually through the mobile device. In one embodiment the configurable payment card may be automatically deactivated if an attempt is made to use the card at a location that is not in proximity to the user's mobile device as tracked by location services features of the mobile device.

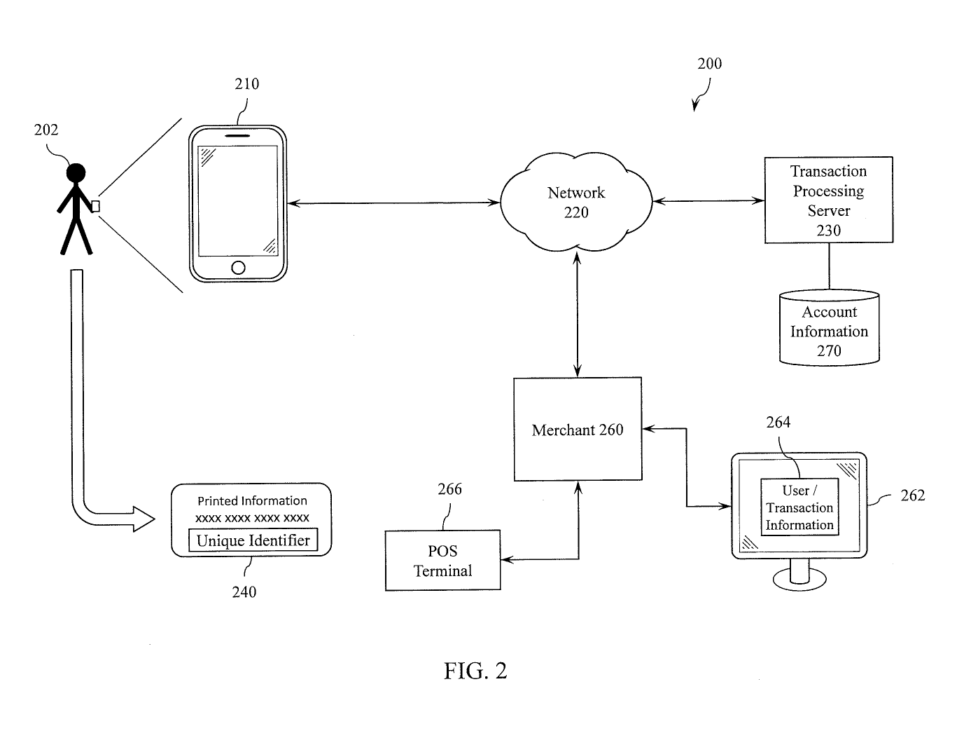

An embodiment of an exemplary network system 200 suitable for processing configurable payment card transactions is illustrated in FIG. 2. System 200 may comprise or implement a plurality of devices, servers, and/or software components that operate to perform various methodologies in accordance with the described embodiments. Exemplary devices and servers may include mobile devices, stand-alone computers, and enterprise-class servers that include a processor and instructions stored in a computer-readable medium that are executable by the processor to perform the computer-implemented methods described herein, including operating an operating system (“OS”) such as a MICROSOFT® OS, a UNIX® OS, a LINUX® OS, iOS®, Android™ or other suitable device and/or server based OS. It can be appreciated that the devices and/or servers illustrated in FIG. 2 may be deployed in other configurations and that the operations performed and/or the services provided by such devices and/or servers may be combined or separated for a given embodiment and may be performed by a greater number or fewer number of devices and/or servers. One or more devices and/or servers may be operated and/or maintained by the same or different entities, and communications between devices and servers may be encrypted to provide communication security.

System 200 includes a user device 210, a network 220, a transaction processing server 230, a configurable card 240, and a merchant system 260. The user device 210, transaction processing server 230 and merchant system 260 are computing devices configured to communicate over the network 220, and each includes one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 220.

User device 210 may be implemented using appropriate hardware and software configured for wired and/or wireless communication with the transaction processing server 230 over the network 220. In various embodiments, the user device 210 may be implemented as a smart phone, tablet, laptop computer, personal computer, smart watch with appropriate computer hardware resources, wearable technology with appropriate computer hardware, and/or other types of computing devices capable of transmitting, receiving and processing data as described herein. Although only one user device is shown, a plurality of user devices may function similarly and be used within the spirit of the illustrated embodiment. One or more of the applications, processes, and/or features discussed below in reference to user device 210 may be included in a communication device connected to user device 210.

Network 220 may be implemented as a single network or a combination of multiple networks, such as the Internet, one or more intranets, local area networks, wide area networks, mobile communications networks, landline networks, wireless networks, and/or other appropriate types of networks capable of facilitating communications between the user device 210, the transaction processing server 230, and the other components of system 200 as described herein. Communications between devices and servers via the network 220 of personal, account, location and other sensitive information may be encrypted to ensure confidentiality.

The transaction processing server 230 facilitates electronic payment processing services using the configurable payment card 240 and includes one or more servers incorporating one or more processing applications configured to interact with user device 210 and a merchant system 260 as described herein. The transaction processing 230 includes account information database 270 storing account information for a user 202, which includes a unique account identifier such as an account number, user 202 identification information, an account balance, transaction records, and configurable payment card information associated with the account. In one example, the service provider may be PAYPAL®, Inc. of San Jose, Calif., USA. Although only one server is shown and data for a single user is described, a plurality of servers and/or associated devices may function similarly for a plurality of user accounts and devices.

Configurable payment card 240 is a payment card allowing the user 202 to enter into financial transactions associated with the user account and is compatible with at least one merchant system 260. The configurable payment card 240 may be implemented as or take the form factor of a credit card, debit card, a virtual card or embody another electronic payment mechanism that is compatible with merchant system 260 and transaction processing server 230. Although only one card 240 is shown, a plurality of configurable payment cards 240 may be used. In the illustrated embodiment, the configurable card 240 is a credit card including printed information identifying the configurable payment card to the user 202 and a unique identifier associated with the transaction processing server 230. The unique identifier may be stored and accessed in a machine readable format such as an RFID tag, NFC chip, magnetic information strip, barcode or QR code that is readable by a merchant point-of-sale terminal 266. The configurable payment card 240 may also include a printed card number that may be manually input to a payment system or used for online purchases.

An exemplary operation of the system 200 will now be described. The user 202 requests the card 240 from the financial institution at which the user 202 has an account, for example, by using the user device 210 to communicate with transaction-processing server 230 over network 220. The configurable payment card 240 is delivered to the user 202 and cannot be used in an electronic payment transaction until associated with a user account and activated. Through the user device 210, the user 202 retrieves the unique identifier of the card 240, activates the card 240 for use with the user's account, and allocates funds from the user account to the configurable card 240. Once activated, the configurable card 240 may be used to purchase goods or services through the merchant systems 260's point of sale terminal 266.

The merchant system 260 processes the payment using the merchant's standard credit card or debit card processing systems, including a point of sale terminal 266 for reading unique identifier information from the configurable payment card 240, and transmits the card information and transaction information to the transaction processing server 230 for payment authorization. The transaction processing server 230 matches the configurable payment card information to the associated user account, verifies sufficient funds are available for the configurable payment card, verifies compliance with other card restrictions stored in the account information database 270 (e.g., authorized user, location, time), and informs the merchant of authorization or rejection of the proposed transaction.

In one embodiment, the merchant system 260 is further configured to interact with the transaction processing server 230 and may include a display 262 which shows authentication and card restriction information 264 to the merchant, such as a photo of the user 202, spending limits, use restrictions, expiration and other account and authorization information received from the transaction processing server 230.

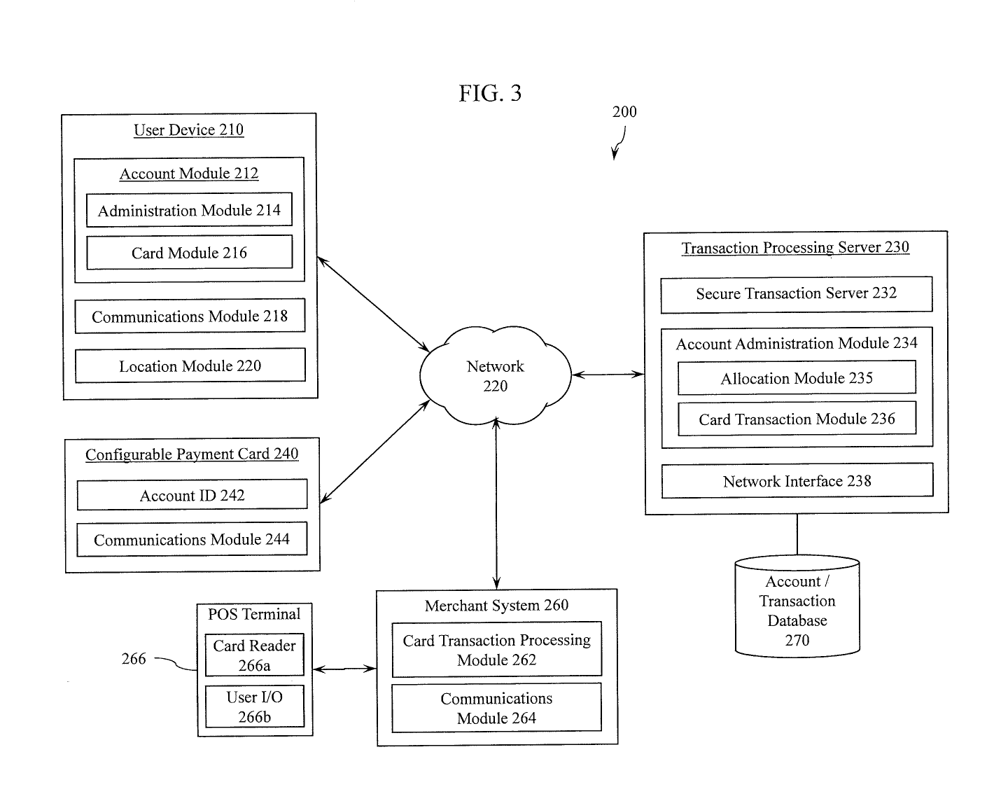

Referring to FIG. 3, an embodiment of exemplary components of the user device 210, card 240, transaction processing server 230 and merchant system 260 are described. User device 210 comprises an account module 212, a communications module 218 and an optional location module 220. User device 210 may include additional or different modules having specialized hardware and/or software as required for the intended use of the device. The account module 212 comprises hardware components and software to facilitate account administration and payment processing through the transaction-processing server 230, and includes user and device authentication processes.

The administration module 214 provides the user device 210 with an administrative interface to manage card transactions through the transaction processing server 230, and manage account settings, budgets and resource allocations. The card module 216 provides an interface for activating, monitoring and deactivating a configurable card. In one embodiment, card module 216 is configured to read the unique identifier from a configurable card 240 and communicate the information to the transaction processing server 230 to associate the card with the user account. In various embodiments, the unique identifier may be stored on the card as a bar code or QR code and read through a camera function of the user device, a magnetic strip which is read using a magnetic card reader connected to the user device, or an RFID or NFC chip which is read using a communications module 218 of the user device 210. The unique identifier may also be manually entered by user into the card module 216. The card module 216 transmits the unique identifier in a secure message to transaction processing server 230 over network 220.

In operation, the card module 216 receives the status of activated configurable cards from the transaction processing server 230, including spending limits, account restrictions, current balance and recent transactions. The user may track the status of active configurable cards 240 and deactivate a card as desired. In one embodiment, the card module 216 receives real time alerts from the transaction processing server 230 indicating recent card activity and provides an interface allowing the user to authorize certain transactions when requested in a transaction alert.

User device 210 further includes at least one communications module 218 adapted to facilitate communications with the transaction processing server 230 across the network 220. In various embodiments, communication module 218 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. The communications module 218 may also be used for other wireless communications, such as tracking the location of the user device 210 via GPS through the optional location module 220. In various embodiments, communications module 218 may also communicate directly with the configurable card 240 using short-range communications, such as Bluetooth Low Energy, LTE Direct, radio frequency, infrared, Bluetooth, and near field communications (including tap-enabled communications).

Configurable payment card 240 includes an account identifier 242 and an optional electronics communication module 244. The account identifier 242 identifies the card, the user account and payment processing service provider associated with the account. The communications module 244 may include an RFID chip, an NFC chip or other communications protocol used for transaction processing through a merchant point-of-sale terminal. In alternate embodiments, the account ID 242 may be a printed number on the card, a magnetic credit card strip, a barcode or QR code storing the account information. In various embodiments, the card 240 may be implemented as a virtual card, a smart bracelet, smart watch, clothing with wearable technology with appropriate computer hardware, and/or other types of payment systems or computing devices capable of transmitting and/or receiving data as described herein.

In one embodiment, the card module 212 facilitates an electronic payment using a virtual configurable payment card 240. The virtual configurable payment card may be implemented as part of an e-wallet application on the user device 210, including corresponding hardware and software which may comprise a tamper resistant secure element for storing tokens and authentication data to authenticate the user device 210 to the transaction processing server 230, and application software facilitating an electronic payment transaction through the merchant point of sale terminal 266. In other embodiments, the secure element can be any suitable storage element, with different levels or types of security, including a non-secure storage element.

In another embodiment, a virtual card may include a unique certificate sent to the user device 210 from the transaction processing server 230. The user may use the card module 216 to logon to the transaction processing server 230 to receive or display a time stamped virtual payment card, which is then read by the merchant system 260 while the user is logged in. In another embodiment, the virtual configurable payment card is a PayPal card, with an embedded security certificate, which is used for preauthorized payments. The image could be used by the user device 210 to make a payment (such as by reading a QR code from the user device) or via an NFC payment or e-wallet application on the user device. The virtual configurable payment card image can be set as a funding source for any PayPal transaction. As with a physical card, an electronic image card can be limited by amount, merchandise type, and time period, and can be shared with other user devices. In one embodiment, the user application authorizes other account users to access an image card via a separate account logon and application.

In another embodiment, a virtual card may include an e-wallet payment token. The user device encrypts a transaction message using an encryption key that is unique to the user device and transmits the encrypted transaction message and a token to the merchant. The transaction message may include information identifying the date, time, merchant, item purchased and transaction amount. The token is a unique identifier (e.g., maybe similar to a credit card or gift card number) that associates the transaction to the primary user's account. The transaction message is transferred to the transaction-processing server which deconstructs the message and authenticates the token and that the user device is the source of the message.

In various embodiments, the user device 210 may include other applications and device components as may be desired. For example, the user device 210 may include security applications for implementing client-side security features, programmatic client applications for interfacing with appropriate application programming interfaces (APIs) over network 220, games, fitness tracking applications, email, texting, voice and IM applications, and other application and features. The user device 210 may also include financial applications, such as banking, online payments, money transfer, or other financial applications, software programs, executable by a processor, including a graphical user interface (GUI) configured to provide an interface for the user.

Transaction processing server 230 includes a secure transaction server 232, an account administration module 234, a network interface 238 and database 270 storing account, card and transaction information for a plurality of users. In other embodiments, transaction-processing server 230 may include additional or different modules having specialized hardware and/or software as required.

Secure transaction server 232 may correspond to one or more processes to execute modules and associated devices to process transactions with regard to use of a configurable payment card 240. The secure transaction server 232 may correspond to specialized hardware and/or software utilized to receive a request from a merchant system 260 to authorize a payment transaction. In various embodiments, secure transaction server 232 enforces restrictions on the use of the configurable payment card 240 through account administration module 234, which associates the card to a user account and verifies compliance with all restrictions. If a card transaction is initiated from the user device 210, secure transaction server 232 verifies whether the user and user device 210 are authenticated, and whether the requested transaction is an authorized use of the user account.

In operation, the each payment transaction includes a card number, transaction amount and a merchant account identifier (other information may include card holder name, expiration date, date and time of the transaction), and the transaction processing server identifies the account associated with a received transaction message and verifies sufficient funds and other restrictions are met before authorizing the funds in a message transmitted back to the merchant system 260. After the transaction is authorized, the merchant completes the payment using the merchant system 260. In one embodiment, if the account lacks sufficient funds or other restrictions are not met, a notification is sent by the secure transaction server 232 to the user device 210 informing the user that the transaction has been denied. The user can then complete the transaction by using an alternative card or retry the transaction after addressing the lack of funds or account restriction manually through the account module 212 (e.g., by manually transferring additional funds to the card). In one embodiment, an “override” or “authorize” option is available to the user as part of the notification, allowing the user to instruct the secure transaction server to authorize the rejected payment in real time.

The account administration module 234 interfaces with the account module 212 of the user device 210 and the account/transaction database 270 to provide the user with access to account information and an interface to configure budgets, allocations and account preferences. In the illustrated embodiment, the account administration module 234 includes an allocation module 235, which is adapted to allocate available account resources (e.g., money or available credit) to one or more virtual accounts or configurable payment cards in accordance with rules established by the user.

The card transaction module 236 interfaces with the card module 216 and secure transaction server 232 to establish and implement restrictions on payment transactions initiated using the configurable payment card 240. In various embodiments, restrictions may be geographic (e.g., can only spend money at an amusement park), time and date based (e.g., can only spend on the weekends), use restricted (e.g., can only use the funds to purchase food; one-time use only) and spending limit restricted (e.g., no purchase over $20). The defined restrictions are stored in the account/transaction database 270.

Network interface component 238 is adapted to communicate with user device 210 and merchant 260 over network 220. In various embodiments, network interface component 238 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

In one embodiment, the merchant system 260 includes a card transaction processing module 262 which processes electronic payments using the merchant's standard payment processing systems (e.g., a credit card payment system), including a point of sale terminal 266 for reading information from the configurable card 240, and transmits the card information and transaction information to the transaction processing server 230 for payment authorization. The point of sale terminal 266 includes a card reader 266a for reading account information from the card 240, and may include a reader for reading a magnetic strip of the card, an RFID or NFC reader, a bar code scanner or other technology configured for reading the card information. The point of sale terminal 266 may also include a keypad, touch screen or other user I/O 266b allowing the user to interact with and personally authenticate/authorize the transaction, such as by entering a PIN number or providing a user signature. A communications module 264 is configured to establish and carry out secure communication of transaction information between the merchant system 260 and the transaction processing server 230 over the network 220.

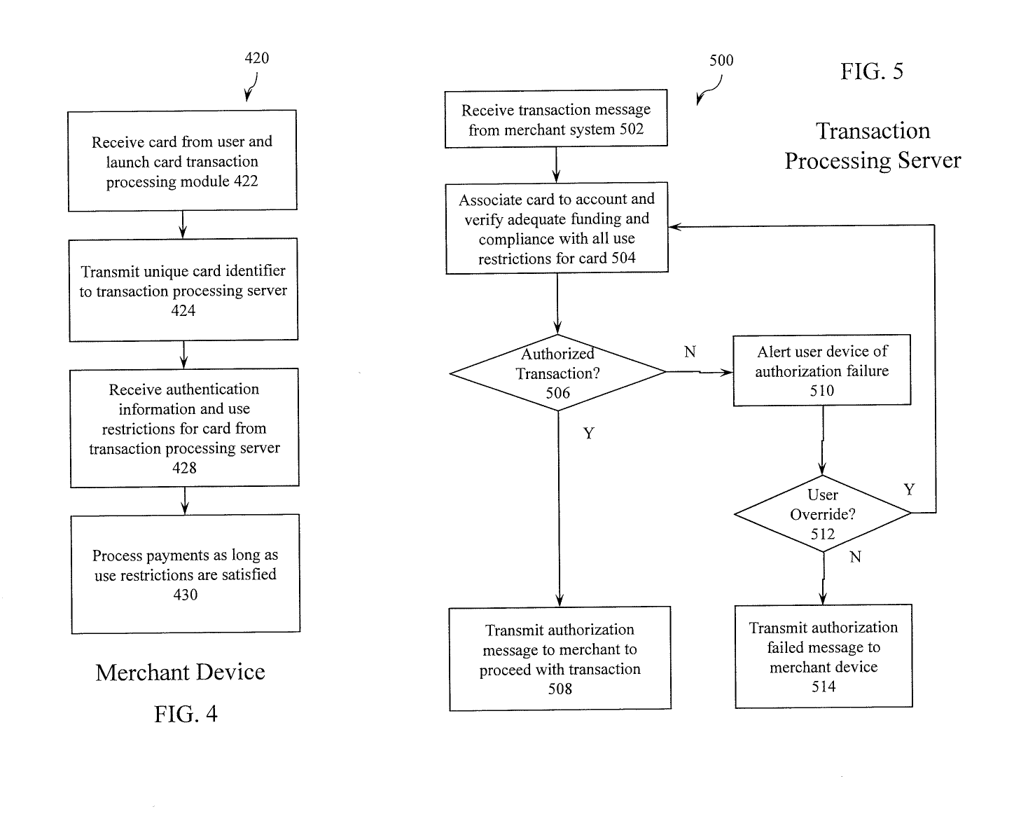

Referring to FIG. 4, an embodiment of authentication steps 420 performed by the merchant system for use in opening a payment tab is shown. In step 422, the merchant system receives a configurable payment card from the user and launches a card transaction processing module. In step 424, the merchant system reads the card and transmits a unique card identifier to the transaction processing server of the payment processing service. In step 428, the merchant system receives authentication information from the transaction processing server, along with spending limits and use restrictions for the card. In step 430, the merchant processes payments on the card as long as the use restrictions and spending limits are met.

FIG. 5 is a flow chart 500 of an embodiment of an exemplary process for processing a payment transaction using a configurable payment card. In step 502, the transaction processing server receives a transaction authorization request message from a merchant system, including a unique card identifier. In step 504, the transaction processing server identifies the associated user account for the card and verifies adequate funding for the transaction and compliance with all use restrictions placed on the card.

If transaction is authorized (step 506), then the transaction processing server transmits an authorization message to the merchant who proceeds with the financial transaction in step 508. If the transaction is not authorized, then an alert is sent to the user device in step 510, providing the user with an opportunity to approve the payment, reallocate funds to the card, or remove a use restriction on the card. In step 512, if the transaction processing server receives account or transaction instructions from the user in response to the alert, then the transaction is re-authorized in step 504. If the user does not overcome the payment restrictions, then in the step 514 the transaction processing server transmits a message to the merchant system notifying the merchant that the transaction has been rejected.

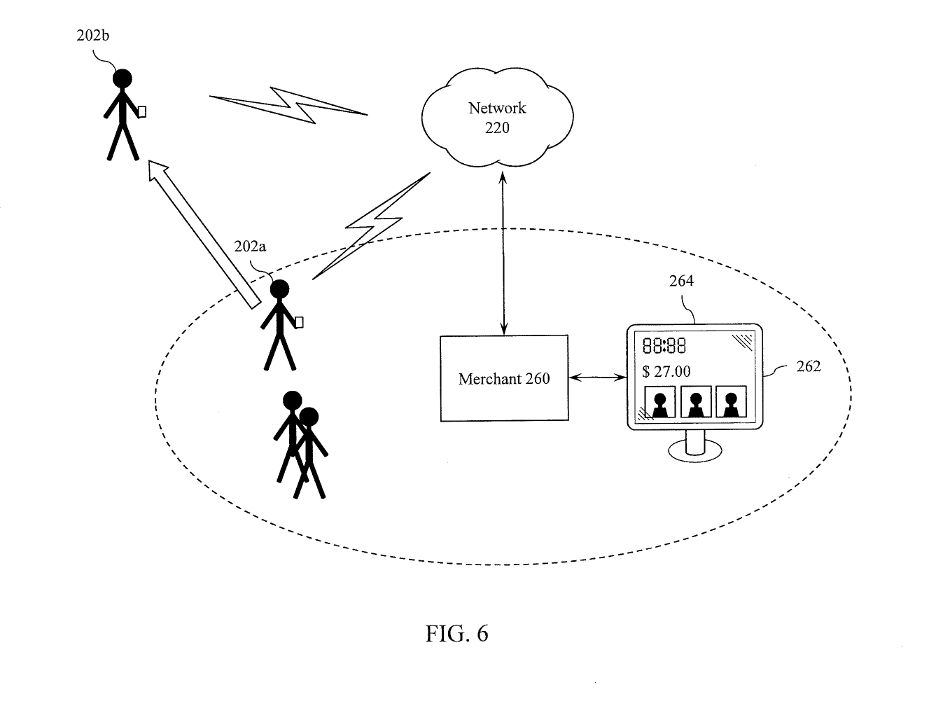

FIG. 6 illustrates an embodiment of a configurable card transaction used to maintain a bar tab using a location restriction. In this embodiment, the user 202 is at a local establishment of merchant 260 and uses a card to open a tab for ordering food and drinks. The card is set up as a single-use card and once used, may only be used at that single merchant. The user sets a spending limit, a time limit and a geographical limit for the card. In addition, through the user device, the user may also take a photo of other authorized users or otherwise select authorized users (such as selection from a user address book or contact list), which are uploaded to the transaction processing system. When the card is used at the merchant 260, the merchant system 260 retrieves account information from the transaction processing system, which may include a time limit, dollars remaining on the tab and photos (or other identifiers) of individuals authorized to use the tab. When a person orders food or drink on the tab, the bartender may look at the display to match the individual with the authorized user photos and authorize payment accordingly. If the user 202b leaves the geographic vicinity of the merchant 260, the user device notifies the transaction processing system, which alerts the merchant, and the card is deactivated for further use.

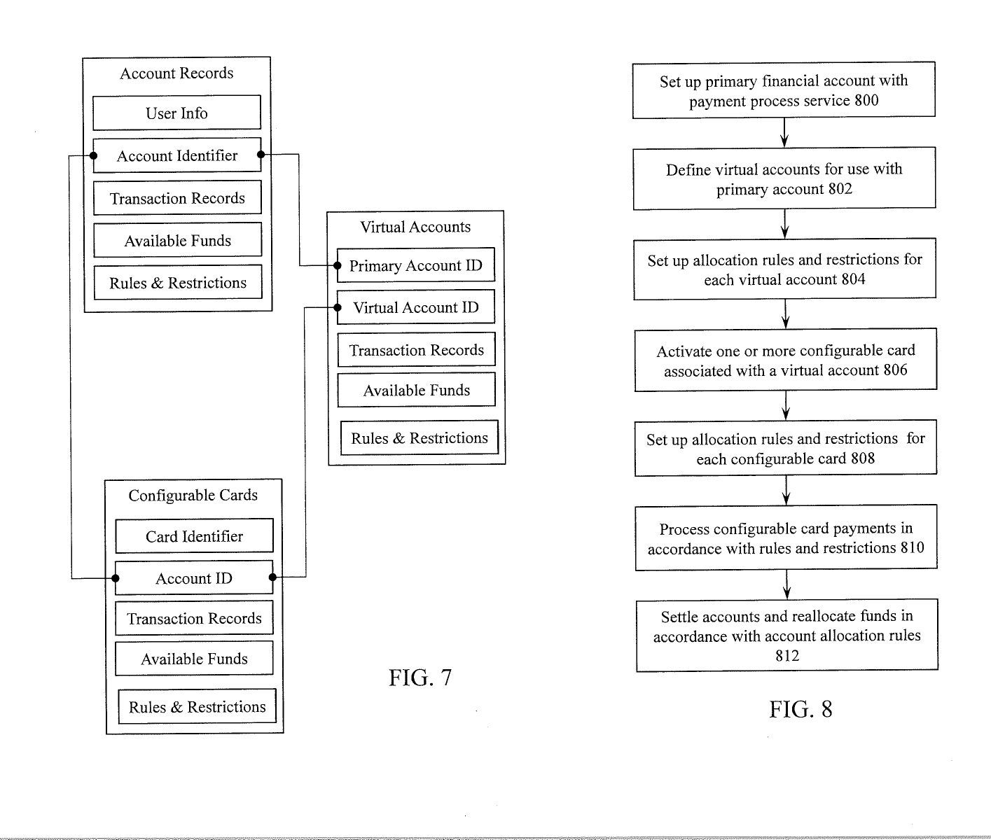

Referring to FIG. 7, an exemplary account database structure will be described. The account database stores account records including information for each financial account, including user information, a unique account identifier, transaction records, fund balance, and rules and restrictions on the account. Configurable payment cards information is stored including a card identifier, an associated primary account identifier, transaction records for the card, available funds allocated to the card and rules and restrictions on use of each configurable card.

In one embodiment the user has an account, such as a bank account, debit card account, or credit card account. The user defines budget categories and allocates money to different virtual accounts with each virtual account having allocated funds, rules and use restrictions. With each virtual account, the user sets up one or more cards for spending on that account. For example, each virtual account can represent a budget category (e.g., gift cards) and the user can set up cards for different uses such as one-time use cards for a bar tab or a gift account for holiday shopping. The user can manage and replenish the cards as needed, e.g., if one card has reached a limit, the limit for that card may be increased and a limit for another card of the user may be decreased, such that the overall budget for the cards is maintained. Each account can be set up to allocate and balance funds between accounts, such as for savings, discretionary funds and non-discretionary spending. When a card expires, the unused allocated funds can be reallocated to other accounts.

An exemplary method for budget management using configurable cards and a budget module on the user device will now be described with reference to FIG. 8. In step 800, the user establishes a primary user account with a financial institution, e-commerce services provider or other payment processing service. In step 802, the user defines virtual accounts and allocation rules for each virtual account. For example, virtual accounts may include bills and utilities, savings, gifts, clothes, entertainment, and food. In step 804, the user sets up budget allocation rules and restrictions between virtual accounts. For example, a user may have mandatory and discretionary expenses, with the mandatory expenses allocated first and discretionary savings and spending allocated among remaining virtual accounts using set dollar amounts, minimum or maximum funding, and percentage/proportional allocation of available funds as set by the user. In one embodiment, initial allocations are made when money is deposited into the account and adjusted manually as needed or on the occurrence of an event. For example, if an unexpected mandatory expense is received (such as a high utility bill) an alert may be sent to the user informing of the need to reallocate funds. Reallocation can include (i) mandatory allocation of mandatory expenses (e.g., based on received bills; known recurring payments such as mortgage and car payments, historical spending) and goals (e.g., long term savings goals), (ii) distributed allocation of discretionary funds, (iii) allocation of unused funds to certain accounts, and (iv) reallocation based on existing account settings.

In step 806, the user activates one or more configurable cards for each virtual account. For example, a food budget may include cards for each child in a family with funds allocated across family members. In step 808, the user may further restrict use of and allocation funds to each configurable card, including configuring a card as a one-time use card, gift card or prepaid card. In step 810, the system processes payments from configurable cards and tracks the available funds through the configurable cards and virtual accounts. In step 812, account allocation rules transfer funds between virtual accounts based on scheduled and triggered events. For example, the depletion of an account may trigger the reallocation of funds across accounts. A non-discretionary utility bill may reduce discretionary spending funds. Upon deactivation of a card, funds may be reallocated back to the virtual account and the funds may be available to reallocation among other accounts as needed. In this embodiment, configurable cards can be set up for use in accordance with the user's spending habits and preferences. If a card is lost or stolen or fraud is detected, the user can immediately cancel the card without having to disrupt use of the account.

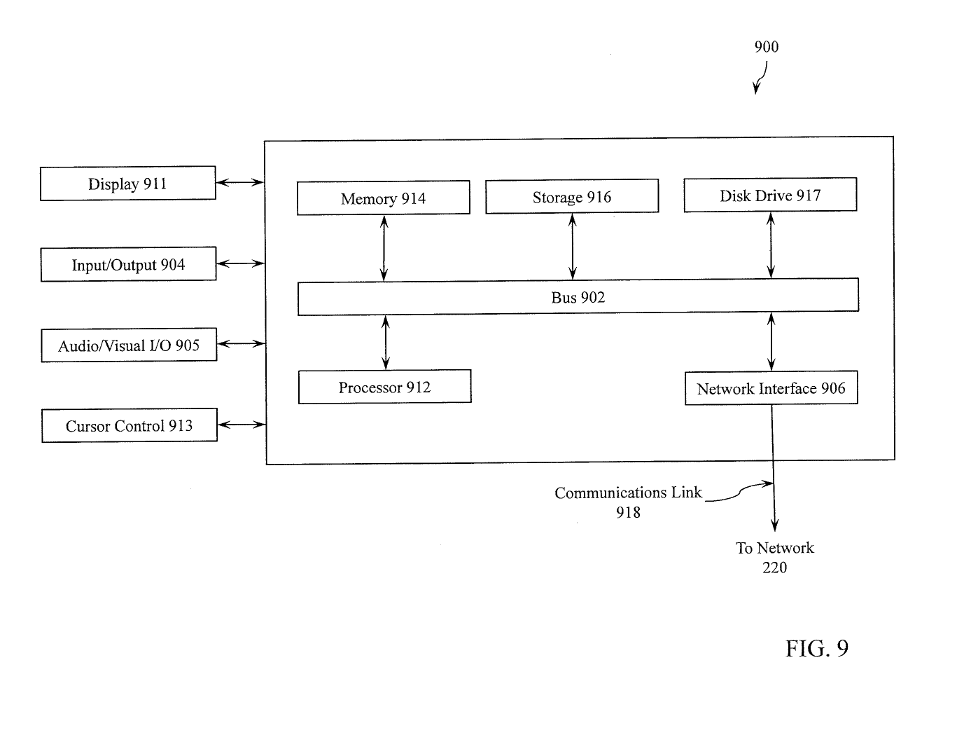

FIG. 9 is a block diagram of a processing system suitable for implementing one or more components described in FIGS. 2, 3 & 6, according to an embodiment. In various embodiments, the trusted user device may comprise a personal computing device (e.g., smart phone, a computing tablet, a personal computer, laptop, a wearable computing device such as glasses or a watch, Bluetooth device, key FOB, badge, etc.) capable of communicating with the network 220. The service provider may utilize a network-computing device (e.g., a network server) capable of communicating with the network. It should be appreciated that each of the devices utilized by users and service providers may be implemented as computer system 900 in a manner as follows.

Computer system 900 includes a bus 902 or other communication mechanism for communicating information data, signals, and information between various components of computer system 900. Components include an input/output (I/O) component 904 that processes a user action, such as selecting keys from a keypad/keyboard, selecting one or more buttons, image, or links, and/or moving one or more images, etc., and sends a corresponding signal to bus 902. I/O component 904 may also include an output component, such as a display 911 and a cursor control 913 (such as a keyboard, keypad, mouse, etc.). An optional audio input/output component 905 may also be included to allow a user to use voice for inputting information by converting audio signals. Audio I/O component 905 may allow the user to hear audio. In various embodiments, the I/O component 904 includes haptic feedback such as tactile vibration to communicate information to the user (e.g., confirmation of a payment action). A transceiver or network interface 906 transmits and receives signals between computer system 900 and other devices, such as another user device, service device, or a service provider server via network 220. In one embodiment, the transmission is wireless, although other transmission mediums and methods may also be suitable. One or more processors 912, which can be a micro-controller, digital signal processor (DSP), or other processing component, processes these various signals, such as for display on computer system 900 or transmission to other devices via a communication link 918. Processor(s) 912 may also control transmission of information, such as cookies or IP addresses, to other devices.

Components of computer system 900 also include a system memory component 914 (e.g., RAM), a static storage component 916 (e.g., ROM), and/or a disk or flash drive 917. Computer system 900 performs specific operations by processor(s) 912 and other components by executing one or more sequences of instructions contained in system memory component 914. Logic may be encoded in a computer readable medium, which may refer to any medium that participates in providing instructions to processor(s) 912 for execution. Such a medium may take many forms, including but not limited to, non-volatile media, volatile media, and transmission media. In various embodiments, non-volatile media includes optical or magnetic disks, volatile media includes dynamic memory, such as system memory component 914, and transmission media includes coaxial cables, copper wire, and fiber optics, including wires that comprise bus 902. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 918 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for processing a payment transaction using a configurable payment card comprising:
a database storing user account information and payment transaction data, the user account information including a primary account identifier, a card identifier for a configurable payment card, and at least one user-configured use restriction on the configurable payment card; and
a transaction processing server communicably coupled to the database and configured to receive a payment transaction message including a transaction card identifier and transaction information, identify the user account associated with the transaction card identifier, verify compliance with the associated restriction on the use of the configurable payment card, and process the authorized payment transaction through the user account;
wherein the user-configured use restriction requires an associated user device in geographic proximity to the location of the payment transaction.

2. The system of claim 1 further comprising:
an account administration module configured to provide a user interface allowing user configured modifications to the configurable payment card restrictions.

3. The system of claim 2 wherein the account administration module is further configured to receive and process an instruction from a user device to associate the unique card identifier of the configurable payment card to the user account.

4. The system of claim 1 further comprising a budget module configured to define a plurality of virtual accounts associated with the user account, each virtual account having a budget category, an associated funds balance allocated from the user account, and at least one use restriction;
wherein the configurable payment card is associated with one of said virtual accounts and authorization of the payment transaction requires compliance with the use and funding restrictions of the associated virtual account.

5. The system of claim 1 wherein the transaction processing server is further configured to transmit an alert message to the associated user device if the payment transaction fails to authorize due to noncompliance with the user-configured user restriction.

6. The system of claim 5 wherein the alert message includes an instruction for overriding the failed authorization; and
wherein the transaction processing server receives an override message from the associated user device and authorizes the payment transaction through the user account.

7. The system of claim 1 wherein the user-configured use restriction includes a one-time use card restriction; and
wherein the transaction processing server is further configured to disable the configurable payment card after authorizing the payment transaction.

8. The system of claim 1 wherein the user account information further comprises a proximity value and contact information of the associated user device; and
wherein the transaction processing server is further configured to receive a current geographic location the user device, determine a current geographic location of the payment transaction, and compare the distance between the user device and payment transaction to the proximity value.

9. The system of claim 9 wherein the transaction processing server is further configured to disable the configurable card if the distance between the user device and payment transaction exceeds the proximity value.

10. The system of claim 1 further comprising a merchant system comprising:
a point-of-sale system comprising a card reader adapted to read the unique card identifier from the configurable payment card and request authorization for the payment transaction from the transaction processing server; and
a display configured to display transaction information, including authorization information and at least one use restriction associated with the configurable payment card.

11. A method for processing a payment transaction comprising:
storing user account information and payment transaction data, the user account information including a primary account identifier, a card identifier for a configurable payment card, and at least one user-configured use restriction on the configurable payment card;
receiving a payment transaction message including a transaction card identifier and transaction information;
identifying the user account associated with the transaction card identifier;
verifying compliance with the associated restriction on the use of the configurable payment card; and
processing the authorized payment transaction through the user account;
wherein the user-configured use restriction requires an associated user device in geographic proximity to the location of the payment transaction.

12. The method of claim 11 further comprising:
receiving instructions from the user device to associate the card identifier to a user account.

13. The method of claim 12 further comprising:
establishing secure communication with an account module on the user device, the account module configured to read the card identifier from the configurable payment card; and
receiving the card identifier from the account module on the user device.

14. The method of claim 11 further comprising:
receiving and processing an instruction from the user device to configure a new restriction on the user of the configurable payment card.

15. The method of claim 11 further comprising:
defining a plurality of virtual accounts associated with the user account, each virtual account having a budget category, an associated funds balance allocated from the user account, and at least one use restriction; and
associating the configurable payment card with one of said virtual accounts;
wherein authorizing the payment transaction requires compliance with the use and funding restrictions of the associated virtual account.

16. The method of claim 11 further comprising:
transmitting an alert message to the associated user device if the payment transaction fails to authorize due to noncompliance with the user-configured user restriction.

17. The method of claim 16 wherein the alert message includes an instruction for overriding the failed authorization, method further comprising:
receiving an override message from the associated user device; and
authorizing the payment transaction through the user account.

18. The method of claim 11, wherein the user-configured use restriction further comprises a single-use payment tab, wherein the payment transaction comprises a request from a merchant to open a payment tab; and wherein the configurable payment card is deactivated after the payment tab is closed.

19. The method of claim 18 further comprising:
closing the payment tab and deactivating the configurable payment card for further use if the user device is detected outside the geographic proximity of the payment transaction location.

20. The method of claim 19 wherein the single-use payment tab is a bar tab with a spending limit that may be used by preauthorized individuals, the method further comprising:
receiving at least one photo from the user device of an authorized user of the configurable card; and
transmit the photo to the requesting merchant for use in authorizing payment transactions on the bar tab.
